(19) United States
(12) Patent Application Publication
(10) Pub. No.: US 2005/0025313 A1
(43) Pub. Date: Feb. 3, 2005

(54) Digital imaging system for creating a wide-angle image from multiple narrow angle images

(76) Inventors: Robert A. Wachtel, St. Cloud, FL (US); John Keable, Hilton Head Island, SC (US); Richard Paulson, Kissimmee, FL (US); William S. Kwolek, Manchester, MI (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/872,127

(22) Filed: Jun. 18, 2004

Related U.S. Application Data
(60) Provisional application No. 60/479,410, filed on Jun. 19, 2003.
(60) Provisional application No. 60/479,411, filed on Jun. 19, 2003.
(60) Provisional application No. 60/486,410, filed on Jul. 10, 2003.

(51) Int. Cl. G09C 5/00

(52) U.S. Cl. 380/54

(57) ABSTRACT

An imaging system for obtaining a wide field of view comprises a plurality of imaging devices each having a defined field of view and each of the imaging devices having a mechanism for capturing an image at a selected time instant. The imaging devices are positioned such that the field of view of each device overlaps the field of view of each adjacent device. A control module simultaneously actuates each of the imaging devices to capturing an image within the field of view of all devices concurrently. The resulting images from each of the devices are merged to produce a wide field of view image.

### SPECIFIC DATA RELATED TO THE INVENTION

This application claims the benefit of U.S. provisional applications, Application No. 60/479,410 filed Jun. 19, 2003; Application No. 60/479,411 filed Jun. 19, 2003; and Application No. 60/486,410 filed Jul. 10, 2003.

### FIELD OF THE INVENTION

The present invention relates to photographic image processing and reproduction and, more particularly, to a method and apparatus for creating composite, wide angle images.

### BACKGROUND OF THE INVENTION

It has been recorded that as early as the 1880's the idea of including more of an image on a print than what was available from a lens was attempted. The early inventions moved the camera as well as the film to allow synchronization with the field of view. The result was a developed film that contained a 360 degree (or less) image. The left part of the print was taken earlier than the right part of the print. This time slippage created image anomalies such as double images of moving objects within the multiple fields of view used to create the composite print or image.

As technology progressed, the same type of wide view camera, referred to as the moving camera technology, has significantly been refined. One embodiment rotates a mirror instead of the camera but still requires multiple images to encompass the desired field of view. The fundamental problem with this type of camera system is that it creates time slippage from left to right across the composite field of view.

One attempt to create composite images without a time shift was developed using a parabolic mirror placed perpendicular to a camera lens. Due to the shape of the mirror, a 360 degree perpendicular image is focused on the camera lens. The primary problem with this camera system is that the 360 degree image appears circular on the camera film or sensor when projected to a flat print, the resulting image has visible anomalies much like a Mercatur map projection of the earth.

More recently, the advent of digital camera technology has enabled photographers to rapidly acquire multiple digital images by rotating the field of view of a camera while collecting images. Computer programs have been developed for combining these multiple images into a composite image. However, notwithstanding the smaller time shift across the composite image, images attempting to capture action events such as automobile racing or basketball games still result in anomalies from fast moving objects.

### SUMMARY OF THE INVENTION

A broad aspect of the present invention is to provide a multi-overlapping field of view camera apparatus comprising a plurality of lens/sensors.

Another aspect of the present invention is that it defines specific geometries of planar (0-360 degrees in the X or left-right direction and 0 degrees in the Y or up-down direction), multi-planar (0-360 degrees in the X direction and greater than 0 degrees but less than 360 degrees in the Y direction, and spherical (360 degrees in both the X and Y directions).

A particular aspect of the present invention is that in all cases, the geometries must be rigidly fixed in order to create a composite image without artifacts.

Another particular aspect of the present invention is a method processing the individual overlapping images obtained from the multi-sensor array fixture and merging them into a composite field of view.

Another particular aspect of the present invention is a method of incorporating artificial intelligence through a complex neural network. Using this technique, the algorithm for registering images is optimized as well as allowing the user of the device to remove perspective error.

Another aspect is the construction of a light chamber for housing a multi-lens and multi-sensor array.

Another aspect is the encryption of linked images to preclude viewing by unauthorized personnel.

The present invention comprises a computer controlled image capturing system for capturing images that encapsulate a wide field of view and require distinct images of objects moving at rapid speeds or for capturing time sequence images as an object traverses through a stationary field of view. In one embodiment, the invention incorporates 5 Kodak DX-3900 cameras as imaging devices in a lens/sensor array fixed on a planar platform. In another embodiment, the invention incorporates 9 Kodak DX-4900 cameras as imaging devices in the lens/sensor array fixed on a planar platform. In each embodiment, the cameras can be synchronized and controlled to operate concurrently to capture images within the field of view of each camera at the same instant. Alternately, the cameras can be synchronized to capture images across the field of view of the array with a set time delay between each camera so that multiple images of an object moving rapidly across the array field of view are obtained. The latter embodiment may be useful in tracking flight paths of objects. All of the captured images are transported to a set of digital signal processing (DSP) elements in parallel where they are analyzed and a composite image is constructed.

The invention includes a mechanism for building the camera such that the lens/sensor geometries are ascertained prior to final assembly of the camera using a spherical-like light chamber. One exemplary chamber is built using a regular (equal sided) hexadecagon (16 sides) in both the x and y directions. The lenses are placed in each facet such that each lens is 10 mm in diameter. The relationship of the plane with one lens to another within the same row is exactly 22.5 degrees. If more than one row is required, the angle to adjacent rows is also exactly 22.5 degrees. The size of the hexadecagon is directly proportional to the sensor size. Another chamber architecture uses equally spaced points on a sphere in the form of a Bucky ball.

The invention also discloses that all the individual lens/sensor images be stored as n-lets. That is, for example, if there are 3 lens/sensors in the array, the individual images are stored as electronically linked triplets. In addition, all but the center image of the triplet is encoded with an encryption key. The encrypted images will appear as hidden files while the un-encrypted image will appear as a specific file within the camera. The linked image is only available to those applications and devices that possess the appropriate key and software. In this way, the photo processor will be able to analyze, register, and augment the image in accordance with the disclosed imaging algorithms. Yet, those who do not have authorization to use that feature may still use the camera as a single lens device.

### BRIEF DESCRIPTION OF THE DRAWINGS

FIG. 1 is a block diagram of one form of the present invention;

FIG. 2 is a plan view of one implementation of the inventive camera system;

FIG. 3 is a drawing describing line segments and angles when determining the object distance from the apparatus centroid;

FIG. 4 illustrates camera positions to display perspective error;

FIG. 5 is a drawing showing perspective error for FIG. 4;

FIG. 6 is a drawing showing “bow tie” correction to perspective error;

FIG. 7A and FIG. 7B illustrate one form of a multi-sensor array in top and side views;

FIG. 8 illustrates one form of lens correction for the array of FIG. 7;

FIGS. 9A, 9B and 9C show a lens architecture using a Bucky ball design;

FIG. 10 illustrates dynamic reconfiguration of an image matrix;

FIG. 11 is a flow chart showing one method of image encryption and storage; and

FIGS. 12A, 12B and 12C illustrate hardware systems used in conjunction with the process illustrated in FIG. 11.

### DETAILED DESCRIPTION OF THE INVENTION

The invention 10 is diagrammatically shown in FIG. 1 and comprises a lens/sensor array 18 having a plurality of imaging devices or lens/sensors 12. The lens/sensors are typically a focusing lens positioned adjacent a digital sensor such as a CCD array. Each lens/sensor array may be focused on a scene, portion of a scene or another image taken with a film-based camera. A controller 19 controls the functions of the lens/sensors 12. A software program or standard combinational logic defines the operation of this element. In one form, controller 19 may be an electronic or mechanical switch array for providing control signals such as shutter or capture start/stop to each lens/sensor 12.

The software program is resident in a DSP program module 26 and effects control of controller 19 through a DSP processor 24. The image data (pixel data) is received by a mapper 20 which moves the pixel data from each lens/sensor 12 to specific addresses in a global memory 21, which may be RAM memory.

A DSP memory 22 is a conventional memory module and associated processor for Direct Memory Access (DMA) to Global Memory 21. DSP memory 22 is operatively coupled to the DSP array 24 which comprises a plurality of DSP integrated circuits (25). A software program resident in module 26 defines the operation of the DSP array.

A formatter 56 converts the pixel data into a form that can be used by viewers and printers. Typically, the pixel data is placed in a JPEG format.

An output module 58 sends the formatted image data to a viewing or printing device. All of the electronic modules are powered from a common regulated supply 60. While the supply 60 is conventional, it should be noted that each CCD sensor must be regulated to provide equal intensity from each sensor in order to avoid differing light levels.

In one embodiment of the invention, the array 18 uses Kodak DX-3900 cameras for lens/sensors 12. Five cameras are arranged in a geometry such that each camera lens is placed equidistance from a central point and aligned on a radius from the point such that the subtended angle between each lens/sensor 12 is 45 degrees. Power is supplied using a common 6.3 volt lead-acid battery coupled to individual voltage regulators for each camera. Controller 19 is implemented by modifying each DX-3900 and connecting focus and capture leads to relays controlled by module 62 which provides a single concurrently to each camera 12 through a single activation switch.

In another embodiment, the array 18 uses nine Kodak DX-4900 cameras with each camera corresponding to one of the lens/sensors 12. In this embodiment, the camera lens are positioned in a geometry such that each lens/sensor 12 is placed equidistance from a central point and aligned perpendicularly to a radius from such point such that the subtended angle between each lens/sensor 12 is 22.5 degrees. As in the first embodiment, power is supplied using a common 6.3 volt lead-acid battery and individual voltage regulators for each camera. The controller 19 includes additional switching functions for controlling the additional ones of the camera 12 in response to image capture commands from relay activation module 62. In both embodiments, the modification of the cameras to connect the focus and capture controls to controller 19 will be apparent to those ordinarily skilled in the art.

While the invention as described with reference to FIG. 1 utilizes a plurality of separate cameras, it will be recognized that multiple CCD type image sensors and associated lenses could be incorporated into a single camera body and thereby reduce the unnecessary duplication of functions such as memory storage in each camera. More particularly, the lens/sensor array 18 need be only a plurality of lens/sensors 12 each comprising an optical lens with a light sensor. In the model DX-3900, the sensor is a 3.1 megapixel CCD sensor. In the Model DX-4900, the sensor is a megapixel 4.1 megapixel CCD sensor. The higher the density of the sensor, i.e., the higher the number of picture elements or pixels, the more detail there will be in the captured image. However, the lens also effect image quality and applicants have found that an optical lens with focal length of 35-70 mm provide suitable imaging in most applications. Further, the final image in a panoramic view is preferably obtained using a sensor such as the CCD sensor having a height to width ratio of about 2:3. While CCD sensors are preferred because of their ready availability and light response, it will be recognized that the invention could be implemented with other types of sensors.

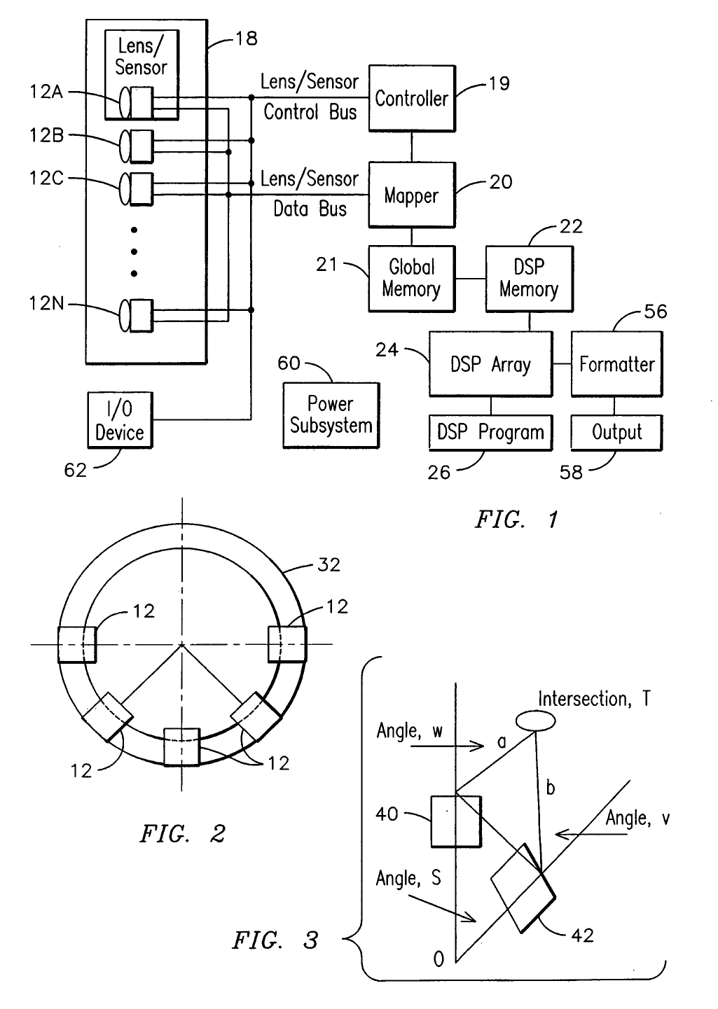

As discussed above, the lens/sensors 12, e.g., digital cameras, are arranged into an array such that each lens/sensor field of view slightly overlaps the field of view of each adjacent lens/sensor. In one form, the lens/sensors 12 are placed in a single plane such that the field of view in the X direction, i.e., horizontal, is up to and including 360 degrees for the composite array. The field of view in the Y or vertical direction, is centered at 0 degrees, i.e., the field of view in the Y direction is a function solely of the field of view of each individual lens/sensor 12. An example of this form of array is shown in plan view in FIG. 2 in which five lens/sensors 12 are uniformly distributed about and equidistant from a center-point 30 on a flat, circular platform 32. Each sensor 12 provides an image which has an overlapping field of view with adjacent sensors. It will be apparent that an increased field of view in a vertical plane can be obtained by stacking multiple levels or planes of lens/sensor with each added level being oriented vertically to have overlapping fields of view with lens/sensors in adjacent levels, i.e., the lens/sensors can be angularly oriented in a vertical direction similar to the orientation in the horizontal direction. Such an arrangement can produce a spherical image sensor array suitable for use, for example, in making stellar images. Clearly, the orientation of the lens/sensors will approach a spherical orientation depending on the desired composite field of view.

Various architectures can be used for the array 18, such as, for example, three lens/sensors configured in a 180 degree planar array with an angular shift of 45 degrees; five lens/sensors configured in a 180 degree planar array with an angular shift of 45 degrees; nine lens/sensors configured in a 180 degree planar array with an angular shift of 22.5 degrees; and eight lens/sensors configured in a 360 degree planar array with an angular shift of 45 degrees.

All of the above are single plane embodiments. For a multiplanar array, various architectures using different numbers of lens/sensors arranged in multiple planes are possible. Some examples are: nine lens/sensors configured in a multiplanar array where one lens/sensors is in a first plane with a center of focus being defined at 0 degrees, three lens/sensors are in a second plane with a center of focus being defined at 0 degrees for one lens/sensor and the other two lens/sensors having an angular shift of 45 degrees, five lens/sensors are in a third plane and the center of focus being defined at 0 degrees for one lens/sensor with the other four lens/sensors having an angular shift of 45 degrees, the angle subtended by the planes being 15 degrees with the third plane being defined at 0 degrees; eleven lens/sensors configured in a multiplanar array where three lens/sensors are in the first plane with a center of focus defined at 0 degrees for one lens/sensor and the other two lens/sensor have an angular shift of 45 degrees, five lens/sensors are in the second plane with a center of focus defined at 0 degrees for one lens/sensor and the other four lens/sensors have an angular shift of 45 degrees, three lens/sensors are in the third plane with a center of focus being defined at 0 degrees for one lens/sensor and the other two lens/sensors have an angular shift of 45 degrees, the second plane being defined as 0 degrees and the first and third plane subtend the angles +15 and −15 degrees, respectively; thirteen lens/sensors configured in a multiplanar array where one lens/sensors is in a first plane with a center of focus at 0 degrees, four lens/sensors are in a second plane with a center of focus defined at 0 degrees for one lens/sensor and the other three lens/sensors having an angular shift of 90 degrees, eight lens/sensors are in a third plane with a center of focus defined at 0 degrees for one lens/sensor and the other seven lens/sensors having an angular shift of 45 degrees, the third plane defined as 0 degrees, the second plane is at 45 degrees and the first plane is at 90 degrees; eighteen lens/sensors configured in a spherical array where one lens/sensors is in a first plane with a center of focus at 0 degrees, four lens/sensors are in a second plane with a center of focus defined at 0 degrees for one lens/sensor and the other three lens/sensors having an angular shift of 90 degrees, eight lens/sensors are in a third plane with a center of focus defined at 0 degrees for one lens/sensor and the other seven lens/sensors having an angular shift of 45 degrees, four lens/sensors are in a fourth plane with a center of focus defined at 0 degrees for one lens/sensor and the other three lens/sensors having an angular shift of 90 degrees, one lens/sensors is in a fifth plane with a center of focus at 0 degrees, the third plane being defined as 0 degrees, the second plane is at 45 degrees, the first plane is at 90 degrees, the fourth plane is at −45 degrees and the fifth plane is at −90 degrees; twenty-two lens/sensors configured in a spherical array where one lens/sensors is in a first plane with a center of focus at 0 degrees, six lens/sensors are in a second plane with a center of focus defined at 0 degrees for one lens/sensor and the other five lens/sensors having an angular shift of 60 degrees, eight

lens/sensors are in a third plane with a center of focus defined at 0 degrees for one lens/sensor and the other seven lens/sensors having an angular shift of 45 degrees, six lens/sensors are in a fourth plane with a center of focus defined at 0 degrees for one lens/sensor and the other 5 lens/sensors having an angular shift of 60 degrees, and one lens/sensors is in a fifth plane with a center of focus at 0 degrees.

I/O module 62 incorporates functions normally found on a conventional digital camera such as focus control, image capture and a view-screen for monitoring images. The module 62 brings all these functions for all lens/sensors 12 into a single module. Additionally, module 62 interfaces with controller 19 to simultaneously apply control signals for image capture and other functions to all lens/sensors. However, the module 62 also includes set-up adjustments to allow individual control of some lens/sensor functions such as, for example, focus, or for setting time delays between actuation of each lens/sensor in order to capture multiple images of a moving object. The controller 19 may be implemented as a group of switching devices responsive to a single signal from module 62 to actuate each lens/sensor 12 concurrently.

The functions related to image captured and pixel data processing are well known and are implemented in the internal electronics of all digital cameras, including the exemplary Kodak cameras. Accordingly, the global memory 21, DSP memory 22 and processing of pixel data are known. The memory modules may be RAM or flash card either separate or part of an associated computer.

One embodiment of the invention uses a PC in lieu of a dedicated DSP array 24 since DSP array 24 is a programmable processor with program control 26. Preferably, the DSP array uses sequential program architecture although parallel processing could be used. The functions implemented in the DSP array include analysis of each of the images for light consistency by calculating a mean brightness level. The analysis may also include maximum to minimum brightness, maximum to minimum contrast, total white space, total black space, and mean contrast.

These parameters are calculated for the entire image and for the image divided into 9 equal sections or image areas (3 on top, 3 on bottom, 3 in the middle, 3 on left, 3 on right, 3 in the middle).

The baseline used for coordination is the mean brightness level and is determined by the mean brightness of the center image of the array. All other images are mathematically transformed (pixel data adjusted) so that their mean brightness is made to equal that of the baseline. This is performed on all nine areas of each image. When transforming with different vectors, a smoothing algorithm is also performed so that image overlap occurs in 25% of the next image area. The other parameters are stored for use by the AI subsystem.

Once corrected for brightness, the adjacent images are merged. The merging process requires several steps. Starting with two adjacent images a single interface line is defined. The present invention uniquely implements merging to form a composite image. Objects are determined by using color differentiation. A line segment is defined as an object and represents a vector where on one side of the vector is one color and on the other side of the vector is another color. The difference in colors is established using a high pass filter and grayscale on the image. The characteristic of the filter is initially a default of 5 pixels but will be enhanced by the AI engine as the device is utilized.

All lenses have distortions in them such as barrel effects or pincushion effects. Each lens in the array 18 is fully characterized at manufacture and these distortions are provided as a matrix of pixel corrections. Distortions generally are common around the edges of a lens so the matrix at the edge has an embedded matrix of more detailed corrections, i.e., the corrections are not linear.

The geometry between each image is defined by the distance, d, between the centroid of the lenses and the angle, alpha, between them. The angle, w, shown in FIG. 3 is the angle between an object in space in reference to a line perpendicular to lens/sensor 40. The angle v is the angle to the same object (given that they overlap) as viewed by lens sensor 42. By recording these angles the intersection, T, of line segments a and b from each lens/sensor is defined. A set of linear equations for each line segment is generated, using the form y=m×+b where m is the slope and b is the y intercept.

Thus, for line segment a with the origin at lens/sensor 40:
yₐ=Cot(w)x

And for segment b with the origin at lens/sensor 42:
y_{b}=Cot(v)x

But for the calculations to follow, the real origin is at the centroid of the array, O. This, then requires the transformation of axes.

For line segment a, with the origin at O: yₐ=Cot(v)x+r, where r is the radial dimension between centroid and lens/sensor.

For segment b with the origin at O, the transformation is: (x′,y′)=(x+rCos(S),y+rSin(S)) where S is the angle between radii to each lens sensor.

By then setting the two equations of the line segments equal to each other, the coordinates (and thus the distance using Pythagorean theorem) of all common objects from the centroid of the array can be determined.

All objects that are common to two adjacent images are determined to have a representative distance, d, from the centroid of the array. This is confirmed by evaluating the following error calculation:

$$ɛ = \frac{\sum \sum \vert {P}_{1} ( x , y ) - {P}_{2} ( x , y ) \vert}{Area}$$

where:
   ε is the minimal error
   Area is the overlapping area
   P(x,y) are the images across x and y.

All common objects of the similar distances are then grouped together into bins. The width of these bins is deterministic.

Points on the objects are selected on the basis of bin identification. Each bin should be represented with a control point. This implies a state variable that is the triplet [d_{bin n}, xₙ, yₙ]. The same point is found in the adjacent image and represented as [d_{bin n+1}, xₙ₊₁, y_{n+1].}

A n-dimensional polynomial transformation is applied to image n+1 in order to merge it to the control points. For every order of the polynomial, four control points are required. The assumption is that the resulting image will be rectilinear. The expansion of the polynomial will determine the number of coefficients. For example for order 2 there will be 6 coefficients (1,x,y,xy, x²,y²) For order 3 there will be 10 coefficients (1,x,y,xy,x²,y²,yx², xy²,x³,y³) For order 4 there will be 15 coefficients and so on.

Curve fitting can be implemented using one of three techniques, i.e., linear least squares evaluation, Levenberg-Marquardt algorithm or Gauss-Newton algorithm.

A significant number of the transformations will not fall on points coincident with the (x,y) pixelation grid. This is corrected by using interpolation. There are three techniques that are used in increasing complexity: nearest neighbor interpolation where the value of an interpolated point is the value of the nearest point; bilinear interpolation where the value of an interpolated point is a combination of the values of the four closest points; and bicubic interpolation where the value of an interpolated point is a combination of the values of the sixteen closest points.

While computationally expensive, the bicubic method is the default technique. It is believed that the bicubic method can be enhanced by weighting functions which gives more emphasis to pixels closer to the transformation point and less emphasis to pixels further away from the transformation point. Computer programs that can be used as part of the merging process include Panofactory 2.1. and Matlab 6.1. It will be appreciated that computer manipulation of pixel data for the merging process is necessary for the large number of pixels that must be processed in order to merge multiple images into a composite image using the above described technique.

Due to the characteristics of the polynomial transformations the composite image will not appear rectilinear and it must be cropped in order to be rectilinear.

It is recognized that many algorithm parameters are statistically based and may not represent the best solution for a given set of images. There are numerous variations in parametric corrections such as:
a. light compensation technique
b. high pass filter response
c. interpolation techniques
d. interpolation weights
e. spatial transformation technique
f. curve fitting threshold

In order to optimize the set, other groupings of these parameters can be implemented and the results displayed to an observer for comparison grading. The grading is recorded in the knowledgebase for future reference. Artificial intelligence (AI) can then evaluate a best set of parameters. Even the individual lens corrections are evaluated and entered into the permanent part of the knowledgebase.

As such, a multi-dimensional neural network is implemented. The memories associated with each node are hierarchical in nature. Issues such as individual lens distortions which create unique polynomials will not change once they have been locked in. Issues such as light compensation, on the other hand, will change with emphasis made on more recent memories (settings).

The artificial intelligence engine is a multi-dimensional neural network. It is a fixed architecture but the weighting functions and thresholds for each perceptron node will be unique to the individual camera, photographer, and/or scenic choice.

The fundamental equations of each node shall be:
temp=((X1*w1)+(X2*w2) . . . (Xn*wn))

If (temp>T) then output is temp, else output=0

Where X1 . . . X n are input elements, w1 . . . wn are weighted elements and T is the overall threshold for that node.

While the background software and initialized-AI engine is fixed, the dynamic nature of the knowledgebase will provide a camera that implements custom software as it is needed. The neural network is implemented using a fixed-perception architecture available in most high-end mathematics software toolboxes, e.g., Matlab 6.1.

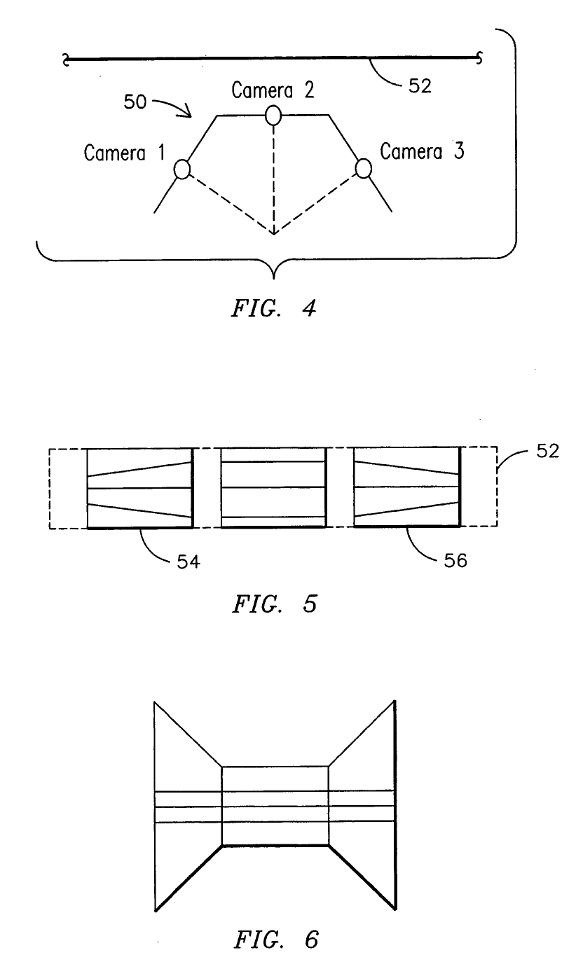

Besides the actual image registration and light average tuning with the AI engine as described above, the problem of perspective error is also linked to the AI engine. The reason it is separated from the other parameters is that it is much more of a psychological phenomenon than a mathematical issue. It is due to the cognitive way in which the human eye sees things and how an individual wants to see scenes. For example, FIG. 4 displays a 3-camera array 50 imaging a wall 52 along with a scene of a straight wall with three parallel lines painted on it. When registered together, the lines would appear as shown in FIG. 5. The narrowing at the far left image 54 and far right image 56 are due to the fact that the straight lines are further away from the camera lens and appear converging to a point source. If, however, the wall 52 was curved with a radius equal to the radius of the array, the lines would look straight since they would be equal distance from the centroid of the array.

There are several ways to deal with the natural but sometimes un-esthetic mapping of images of the type shown in FIG. 5. One way is to leave the pixel map as it is and transform the images from camera 1 and camera 3 with amplification. If done appropriately, this would graphically appear as shown in FIG. 6. This is referred to as the “bow tie correction or effect”. The problem with this is that each individual pixel represents less information at the extremes of the composite photograph. In other words, the pixels look stretched. The gain is a function of distance along the horizontal axis from the center of the scene and it is generally represented as a linear function. Some pixels on both the top and the bottom of the resulting “bow tie” will be lost when the picture is cropped in a standard rectangular format. However, the advantage of this technique is that there is a 1:1 mapping of each pixel.

Another method to deal with spatial distortion of the type shown in FIG. 5 is to modify the pixel maps. Since the fixed geometries of the cameras (FIG. 4) to each other are known, the pixel maps can be modified to make it appear as if from a cylinder. For example, assume the wall 52 is really curved with an arc angle equal to the angle scribed by the lenses, there would be no distortion at all. Without knowing the distance from the wall 52 to the camera array 50, there would be no way of determining the actual case. However, knowing the distance from the camera array 50, each pixel can be modified according to the translation of the wall shape to a cylinder. One way to accomplish this translation is to oversample all of the images by a factor of 4:1 and then apply trapezoidal correction on far-field objects assuming the infinity points are along the horizontal line through the center of the composite image. An object that extends in range from the centroid with respect to its adjacent pixels with the same 3-dimensional equation mapped to 2-dimensions as a straight line segment is tacitly deemed a straight line segment for the correction.

Near-field objects are then translated to composite image without correction. Finally, the pixel data (objects) are interpolated as required. This does imply that the outer pixels have less resolution than the inner pixels. It also implies that, in order to maintain rectangular coordinates there is not necessarily a 1:1 mapping of pixels. Pixels are, in essence, created through interpolation or removed through averaging. The compromise between pixel density and perspective error is aided by creating images with a very large number of pixels/square area. The second embodiment using lens/sensors from a Kodak DX-4900, for example, has 4.1 million pixels for a 35 mm equivalent. In this manner the over sampling interpolation (pixel creation) and under sampling (pixel averaging) is done with minimal informational loss in the result. Note that when an object is only in one image, the object is indeterminant and is defaulted to be the estimate of the closest known object that is bi-located. Selections within the AI engine will ascertain whether or not this option was a good one.

The result of the process described can be presented to a person who selects which of the approaches is preferred. This selection is recorded in the knowledgebase. The degree of compensation is also provided as options until the user makes no change and the degree in which the user selects:
a. 1 much better than 2
b. 1 is slightly better than 2
c. 1 is the same as 2
d. 2 is slightly better than 1
e. 2 is much better than 1

While a user generally selects a full image, it is possible with an AI implementation to select sections of the composite image for augmenting perspective error.

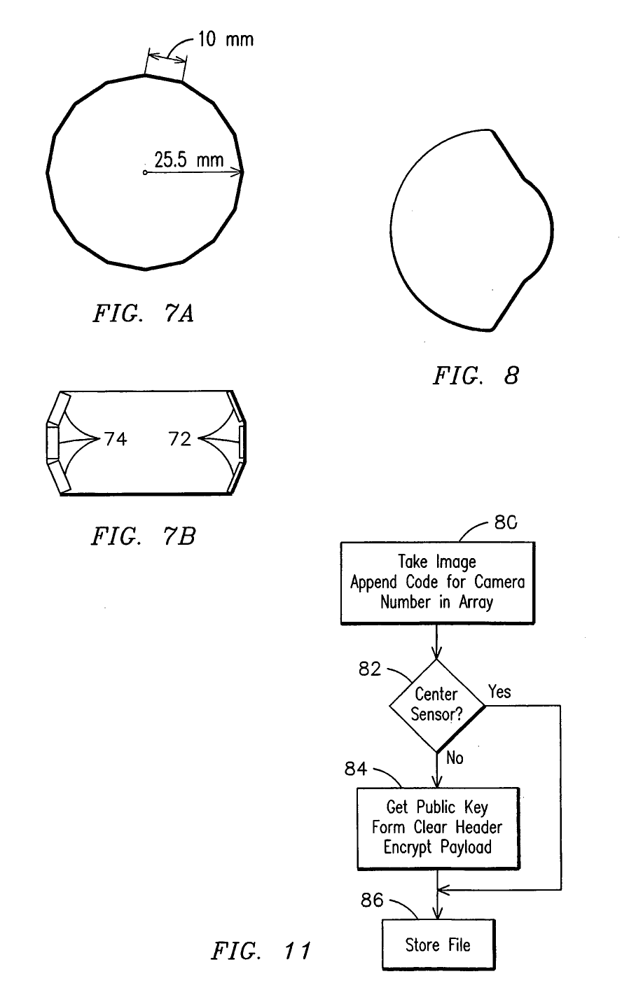

Turning now to FIGS. 7A and 7B, there is shown an example of one form of chamber 70 used to house a multi-sensor array as a hexadecagon. This is a 16-sided polygon sometimes also called a hexakaidecagon. The regular hexadecagon is a constructible polygon, and the in radius r, circumradius, R and area A of the regular hexadecagon of side length 1 are:

$$r = \frac{1}{2} ( 1 + \sqrt{2} + \sqrt{2 ( 2 + \sqrt{2} )} )$$

$$R = \sqrt{\frac{1}{2} ( 4 + 2 \sqrt{2} + \sqrt{20 + 14 \sqrt{2}} )}$$

$$A = 4 ( 1 + \sqrt{2} + \sqrt{2 ( 2 + \sqrt{2} )} ) .$$

In other words, for a 10 mm side, the in radius is 25.1 mm and the circumradius is 25.6 mm. This is graphically shown in FIGS. 7A and 7B.

Each included angle is 360/16 or 22.5°.

Since the imaging array in this embodiment is not spherical, it can be layered as shown in FIG. 7B. The angle between the facets 72 in this perspective is also 22.5°.

The rays of light are focused at the mid-point and then inverted to the sensors 74 on the opposite side. In this manner, then, the maximum lens/sensor pairs is 8. Analysis of imaging prototypes has indicated for at least one type of image (i.e. printed 4″×6″, 4″×7″ formats), the maximum facets would be 7 in 3 layers. Due to the geometries, the 8^{th} space would be blank.

The presupposition in FIGS. 7A and 7B is that the lens 72 are the same size as the sensors 74. This may not be the case. The larger the lens, the better and more consistent the images generally become. Much of this can be corrected in calibration in the software. A second embodiment of the invention is shown schematically in FIG. 8 which shows an example where the lens facets 72 are smaller than the sensor (CCD) facets 74. By compensating with different radii of curvature through the focus point, the light will be well-behaved and symmetric. Likewise, if the lenses were larger than the sensors, the legend of FIG. 8 would be reversed.

Four embodiments of this architecture are possible, i.e.,
1. one plane of 3 lenses
2. one plane of 5 lenses
3. two planes of 5 lenses each (“5 over 5”)
4. three planes of 7 lenses each (“7 over 7 over 7”)

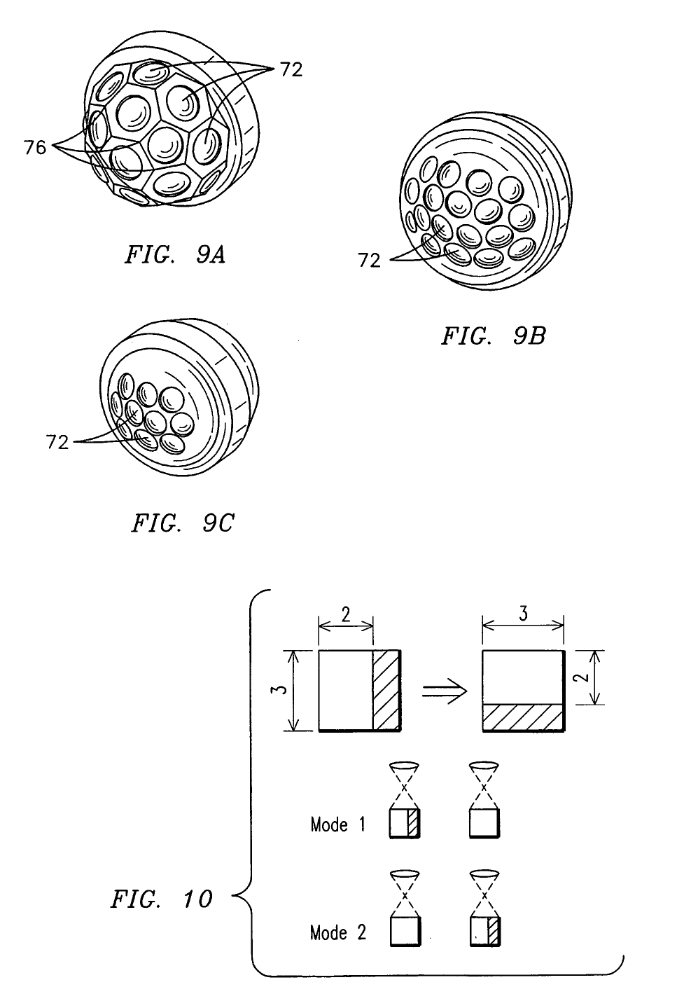

Alternate embodiments shown in FIGS. 9A, 9B and 9C use what is known as a “Bucky ball” architecture. In FIG. 9A, the design is composed of 60 points 76 distributed on the surface of a sphere in such a way that the distance from any point to its nearest neighbors is the same for all the points. Each point has exactly three neighbors. A lens using this structure is shown in FIG. 9A.

FIG. 9B shows a modification of FIG. 9A in which as a result, triangles were added between points 76 to increase the number of lenses 72 to allow for overlap registration of images. The result is an 18-lens structure. The fixed FOV (discounting the focal length of the lenses) is 90° high by 124° wide. The angle between lenses is approximately 22°.

FIG. 9C is a further embodiment of FIG. 9B using a 10-lens structure The fixed FOV (discounting the focal length of the lenses) is 72° high by 93° wide. The angle between lenses is approximately 22°.

Applicants have found that the nearer the format is to a 4×6, the Bucky architecture is superior. As the format elongates, the pixel density of the Bucky architecture decreases.

While many light sensors are configured in a 2:3 ratio, this does not have to be the case. Square sensors can be built and are recommended for this particular invention. The reason for this is the ability to reconfigure the sensors to any aspect ratio.

FIG. 10 illustrates a square 3×3 matrix that can be dynamically reconfigured by simply making null either one column or one row of the matrix.

Tables I and II show calculated values for the lens/sensor designs discussed above and a comparative analysis of the picture/image obtained from each design.

TABLE 1

| | | Pixels using | | Pixels using | | Pixels using |
|---|---|---|---|---|---|---|
| | Total FOV | 4.1 Mpixel | FOV in 4″ × 6″ | 4.1 Mpixel | FOV in 4″ × 7″ | 4.1 Mpixel |
| Lens | using 50 mm FL | sensor | format | sensor | format | sensor |
| 3-lens | 38° h × 69° w | 10.3 Mpixel | 38° h × 60° w | 9.0 Mpixel | 38° h × 67° w | 10.0 Mpixel |
| 5-lens | 38° h × 114° w | 16.4 Mpixel | 38° h × 60° w | 8.6 Mpixel | 38° h × 67° w | 9.6 Mpixel |
| 5 over 5 | 60° h × 114° w | 28.7 Mpixel | 60° h × 90° w | 22.7 Mpixel | 60° h × 110° w | 27.7 Mpixel |
| 10-lens Bucky | 100° h × 125° w | 30.8 Mpixel | 83° h × 125° w | 25.6 Mpixel | 71° h × 125° w | 21.9 Mpixel |
| 7 over 7 over 7 | 83° h × 159° w | 56.4 Mpixel | 83° h × 125° w | 44.3 Mpixel | 83° h × 145° w | 51.4 Mpixel |
| 18-lens Bucky | 120° h × 155° w | 55.4 Mpixel | 103° h × 155° w | 47.6 Mpixel | 90° h × 155° w | 41.6 Mpixel |

Legend:
w = wide, h = high, x = by, FOV = Field Of View, FL = Focal Length, Mpixel = Megapixel

TABLE II
Comparative Analysis

| | Full area of | 4″ × 6″ area of | 4″ × 7″ area of |
|---|---|---|---|
| | picture normalized | picture normalized | picture normalized |
| Lens | to 55 mm | to 55 mm | to 55 mm |
| Normal | 1 | 1 | — |
| 55 mm | | | |
| Normal | 3.3 | 3.3 | — |
| 28 mm | | | |
| Normal | 11.5 | 11.5 | — |
| 17 mm | | | |
| 3-lens | 2.9 | 2.5 | 2.8 |
| 5-lens | 4.8 | 2.5 | 2.8 |
| 5 over 5 | 7.5 | 5.9 | 7.2 |
| 10-lens | 13.7 | 11.4 | 9.7 |
| Bucky | | | |
| 7 over 7 | 14.5 | 11.4 | 13.2 |
| over 7 | | | |
| 18-lens | 20.4 | 17.5 | 15.3 |
| Bucky | | | |

Typically digital cameras record the images taken on some type of removable storage media. These use various technology but the most common being Compact Flash and Smart Media—both using a type of flash non-volatile memory. The media can then be removed from the camera and put into a reader for viewing. Most cameras also allow the uploading of the images via an output port on the camera directly to a reader or computing device.

The camera system disclosed in this application uses a set of lens/sensors creating multiple images of the same scene. By controlling the angle of these lens/sensors and controlling the capture time of each lens/sensor a composite image can be created which is marked with high density and low distortion and error.

In order to create these images, a special algorithm is required as described in the application. It is possible that this software will be provided in something other than the camera. For example, it may reside in a PC application program or in a special purpose high quality printer. In order to safeguard the printing for specified manufacturers, an organizational schema of the image data is defined. This organization will link the images, by array organization, to the single scene. In addition, all but the center image will be 128 bit encrypted. Only the authorized software and printer manufacturers will be provided the appropriate key to unlock all of the images and allow them to be registered and merged.

This image record will be maintained throughout the process including any transmissions of the data through all forms of data transmission techniques including the internet.

FIG. 11 is a flow chart showing one method for control in one aspect of the invention. The header of each file will be in the clear so that the information about the image may be read even though the payload itself will not be. The public key and private keys to the data will be updated on a regular basis. In block 80, the images are acquired and identified. If the image is from the center sensor, block 82, the image is stored. Otherwise, the image is encrypted, block 84, prior to storage, block 86.

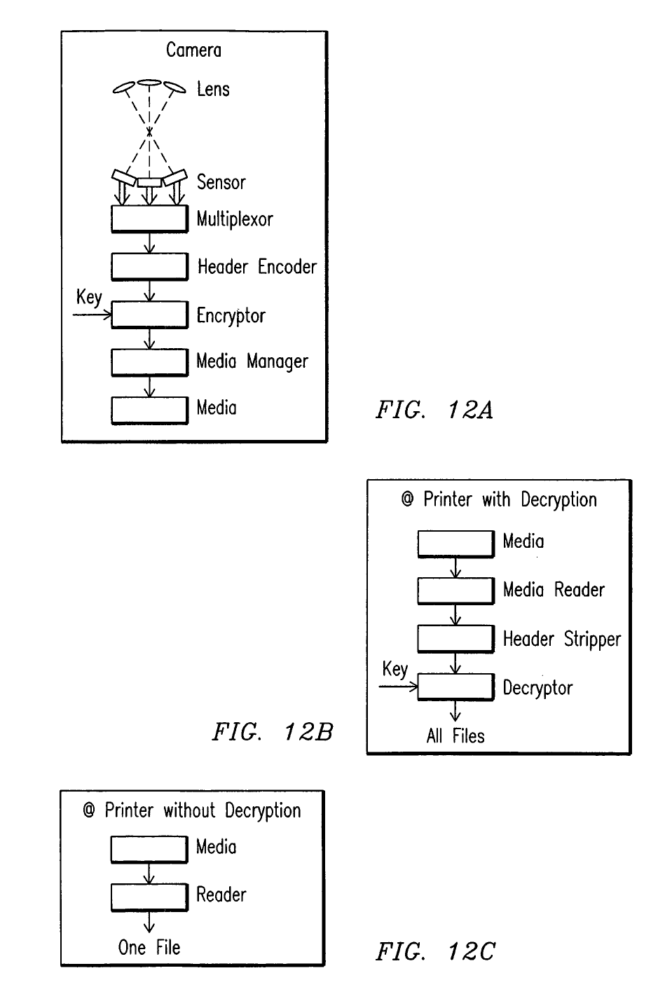

FIGS. 12A, 12B and 12C illustrate functional diagrams of possible systems. FIG. 12A shows encryption incorporated into the camera. FIG. 12B shows decryption incorporated in a printer. FIG. 12C illustrates a printer without decryption.

While the invention has been described in what is presently considered to be a preferred embodiment, many variations and modifications will become apparent to those skilled in the art. For example, while digital imaging is preferred, the invention could use an array of film-based cameras. After the scenes are captured, the film is later removed and developed. The images are then scanned into digital images using commercially available digital scanners. The digital images are then input into the Mapper through a USB port. The set geometries of the film-based camera array design are then used as input data to the DSP program. All other functions of the invention are then executed as described. Accordingly, it is intended that the invention not be limited to the specific illustrative embodiment but be interpreted within the full spirit and scope of the appended claims.

1. An imaging system for obtaining wide field of view images comprising:
an array of lenses spaced uniformly about a common point;
an array of light sensors, each light sensor being associated with a respective one of the lenses for capturing an image impending on such lens; and
means for mounting the lenses such that a plane in which a lens is oriented is 22.5 degrees angular with respect to any plane of any adjacent lens.

2. The imaging system of claim 1 wherein the lens array is a hexadecagon.

3. The imaging system of claim 1 wherein each lens is smaller in diameter than the associated sensor.

4. The imaging system of claim 1 wherein the lens array is three-dimensional

5. The imaging system of claim 4 wherein the array mounting means is formed in the shape of a Bucky ball.

6. The imaging system of claim 5 wherein the number of lenses is greater than a number of facets on an equal size Bucky ball.

7. In an imaging system for creating a wide angle image from a plurality of narrow angle images, a method for preventing unauthorized use of the narrow angle images comprising:
collecting each of the narrow angle images;
determining a center image of the plurality of narrow angle images;
storing the center image in a standard image format;
encrypting each of the remaining narrow angle images; and
storing the encrypted images in association with the center image.

8. The method of claim 7 and including linking each encrypted image to the center image.

9. The method of claim 8 and including providing a decrypting algorithm that concurrently decrypts and combines the plurality of images into a composite image.

10. The method of claim 9 wherein the decrypting algorithm is operable in a printer for printing the composite image.
